(19) United States
(12) Patent Application Publication
(10) Pub. No.: US 2012/0011566 A1
(43) Pub. Date: Jan. 12, 2012

(54) SYSTEM AND METHOD FOR SENSOR NETWORK AUTHENTICATION BASED ON XOR CHAIN

(75) Inventors: Heung-Youl Youm, Chungcheongnam-do (KR); Don-gu Yeo, Chungcheongnam-do (KR); Jae-Cheol Ryou, Daejeon (KR)

(73) Assignee: The Industry & Academic Cooperation in Chungnam National University(IAC), Daejeon (KR)

(21) Appl. No.: 12/938,263

(22) Filed: Nov. 2, 2010

(30) Foreign Application Priority Data
Jul. 7, 2010 (KR) 10-2010-0065358
Jul. 7, 2010 (KR) 10-2010-0065359

(51) Int. Cl. G06F 21/00

(52) U.S. Cl. 726/3

(57) ABSTRACT

Disclosed is a method for sensor network authentication based on an XOR chain, which authenticates a transmitting node and a message in a sensor network including a central server, a plurality of transmitting nodes, and a plurality of receiving nodes, the method comprising the steps of: (a) receiving an initial key from the central server, generating a key chain from the initial key, generating a first key chain parameter sequence from the key chain, generating authentication information by XORing all the first key chain parameter sequence, and generating a second key chain parameter sequence by XORing each parameter of the first key chain parameter sequence with the authentication information, by each of the transmitting nodes; (b) transmitting first and second parameters of the same position in the first and second key chain parameter sequences of the transmitting node together with a message by the transmitting node; and (c) XORing the first and second parameters and comparing a result of the XOR operation with the authentication information, thereby authenticating the message, by the receiving node. By the method, a receiving node can authenticate a transmitting node and a message by only a small quantity of fixed operation regardless of the number of key chains.

### RELATED APPLICATIONS

The present application claims priority to Korean Patent Application No. 10-2010-0065358 filed on Jul. 7, 2010 and Korean Patent Application No. 10-2010-0065359, the disclosure of which is incorporated by reference herein.

### BACKGROUND

1. Field of the Invention

The present invention relates to a system and method for sensor network authentication based on a tree using an XOR chain, in which a receiving node authenticates a transmitting node by XORing parameters of a certificate and comparing a result of the XOR operation with authentication information in a sensor network including a central server, the transmitting node, and the receiving node.

Particularly, the present invention relates to a system and method for sensor network authentication based on an XOR chain, in which a first parameter sequence (which is a first key component) is generated from a key chain, authentication information is formed by XORing all the first parameter sequence (which is the first key component), and a second parameter sequence (which is a second key component) is generated by XORing the first parameter sequence (which is the first key component) and the authentication information.

Further, the present invention relates to a system and method for sensor network authentication based on an XOR chain, in which first and second certificates of a transmitting node are generated by an XOR chain and the transmitting node is authenticated by an XOR operation of the certificates.

Especially, the present invention relates to a system and method for sensor network authentication based on an XOR chain, in which all first certificates of transmitting nodes are XORed to generate a verification certificate, and the first certificate of each transmitting node is then XORed with the verification certificate to generate a second certificate of the transmitting node.

2. Discussion of Related Art

In general, a sensor network includes a receiver (or receiving node; e.g. sensor node), which can collect surrounding environment information, and a transmitter (transmitting node; e.g. base station), which can control the receiver, obtain the collected information from the receiver, and communicate with an entity located outside of the sensor network. One characteristic of the sensor network lies in that the receiver has limited capabilities in view of the power, storage, and operation. Since such a characteristic has an influence on the life of the entire sensor network, active researches have been in progress in order to reduce the load of the receiver during a communication between the transmitter and the receiver as much as possible.

The sensor network uses a wireless communication technology in order to deliver a message between a transmitter (transmitting node) and a receiver (receiving node). In a broadcast scheme used in the wireless communication, any receiver located within a range of an electronic wave of a transmitter can acquire a message from the transmitter. Such a communication as described above is effective in managing sensor nodes in a broad sensor network. However, the low bandwidth of the sensor network, an intermittent communication interruption in the wireless communication, and the limited resources of a sensor node may work as restrictions on authentication of broadcasted messages. Therefore, the conventional security protocol or the conventional authentication scheme in the broadcast scheme of the existing wired network as they are cannot be employed in the wireless communication.

The Security Protocol for Sensor Networks (SPIN) has introduced the μTESLA (or original μTESLA) scheme, which is obtained by applying the Timed, Efficient, Streaming, Loss-tolerant, Authentication (TESLA) protocol supporting a broadcast authentication scheme using a digital signature of a general Personal Computer (PC) level to a sensor network. Since the μTESLA scheme uses a sender's digital signature for authentication, the μTESLA scheme is improper for the sensor network, which has limited resources and uses wireless communication.

According to the original μTESLA scheme, a hash chain is generated by using a hash function, and keys generated in a direction opposite to the direction in which the chain is generated are then broadcasted. That is, the life period of the entire sensor network is divided into n intervals each having a length of intervalΔ₀, to which different authentication keys Kⱼ are allocated. The authentication keys Kⱼ are sequentially allocated in the direction opposite to the direction in which the chain is generated.

A transmitter inserts an authentication key value Kⱼ in a message at every n intervals, and a receiver having received the message hashes the received authentication key value Kⱼ and compares it with a previously received authentication key value Kⱼ, in order to perform the authentication. When the two authentication key values are identical, the receiver determines that the authentication has been successfully completed, and stores the received message. That is, in order to verify the authentication key Kⱼ received in the current interval intervalᵢ, the receiver repeatedly operates, by (j−1) times, a hash function with the authentication key Kⱼ as an input value. Then, the receiver determines if a resultant value of the operations is identical to the most recently used key Kⱼ (at intervalᵢ). When the values are identical, the receiver considers that it is a correct authentication key and replaces the previous key by a current key.

As a result, the receiver stores only a message including the authentication key Kⱼ, which has already been transmitted through the previous message, from among the received messages. A once-opened key is used only up to a time point before the next key is opened, and in this respect, it has characteristics similar to those of an asymmetric key. However, in order to cover the life of the sensor network by one key chain, each interval intervalΔ₀ of the key chain should be considerably long, which may cause a problem of delay in the authentication.

In addition, protocols proposed thereafter include a multi-level μTESLA protocol, which can reduce the authentication time by hierarchically interconnecting multiple short period key chains, and a tree-based μTESLA protocol, which takes multiple transmitters in a broad sensor network into account.

The multi-level μTESLA protocol corresponds to an improvement of the original μTESLA protocol, which can be applied to a sensor network of a larger scale. Characteristics of the multi-level μTESLA protocol are as follows. First, a previous determination method is used to reduce the quantity of data to be transferred in the case of the same μTESLA parameter. Second, a higher layer having a key chain with a long interval and a lower layer having a key chain with a short interval are hierarchically interconnected, so as to reduce the update period of the authentication key. Third, repetitive message transmission is used in order to reduce a message loss and the damage due to a Denial of Service (DoS) attack, and an authentication key of a next interval is added to a Commitment Distribution Message (CDMᵢ) of a current interval in order to reduce the message authentication delay.

That is, the multi-level μTESLA protocol reduces the authentication delay and the update period of the authentication key by dividing n long high level intervals into m short intervals intervalΔᵢ. The distribution message (CDMᵢ) contains an image value of an authentication key K_{i+1,0} to be used in the next interval intervalᵢ. Therefore, when two authentication values are identical as a result of current distribution message (CDMᵢ) reception and H(K_{i+1,0}) operation, the previous distribution message (CDMᵢ₋₁) is authenticated. Thereafter, for an integrity check of the previous distribution message (CDMᵢ₋₁), Kᵢ₋₁, which is the last parameter of the current distribution message (CDMᵢ), is used. In order to enable restoration of the last key K_{i-1,n} of a lower level key chain of the i^{th} interval when it is lost, a higher level key chain and the lower level key chain are interconnected through a hash function.

The original μTESLA protocol and the multi-level μTESLA protocol are proper for a sensor network including a single transmitter connected by wire or wirelessly. When a sensor network includes a single transmitter, data transferred from a plurality of receivers may cause a bottle-neck phenomenon and relay nodes located around the transmitter consume much energy, which in result reduces the life of the sensor network.

The tree-based μTESLA protocol can reduce the bottle-neck phenomenon by taking multiple transmitters in one sensor network into consideration, and can be applied to a wide variety of sensor networks.

According to the tree-based μTESLA protocol, in order to take multiple transmitters in a sensor network into consideration, a certificate sⱼ for each transmitter j and a certificate s_{j,i} for a key chain of a transmitter j in the i^{th} interval are generated, and certificate parameters ParaCertⱼ and paraCert_{j,i} are transferred to the receiver. Each node of the tree is generated by concatenating two adjacent lower level trees and applying a hash function to them.

The tree-based μTESLA protocol can reduce the message authentication delay by using a key chain of a short interval, i.e. intervalΔ₁, and can achieve an instant authentication when receiving certificate parameters ParaCertⱼ and paraCert_{j,i} from a transmitter, by using a previously distributed root value Root_{R} of a higher tree. Further, by using a tree based authentication structure of a higher level for transmitters, it is possible to install a plurality of transmitters in a sensor network.

However, when there are a large number of transmitters or a large number of key chains, the height of the tree increases and the quantity of data of paraCert_{j,i} to be transferred thus increases. As a result, the quantity of communication and the quantity of operation between the transmitters and the receivers increase, which is a shortcoming of the tree-based μTESLA protocol.

A μTPCT-based μTESLA protocol has solved a problem of the tree-based μTESLA protocol that an increase in the number of key chains possessed by a transmitter causes an increase in the quantity of operation in a sensor node. This protocol has been adopted as a broadcast authentication technique in a sensor network by the security framework (X.usnsec−1) for a Ubiquitous Sensor Network (USN), which is being standardized in the ITU-T and ISO/IEC.

In this protocol, a lower tree structure of the tree-based μTESLA protocol is changed to a hash chain structure called a μTESLA Parameter Chain (μTPC), so as to reduce the quantity of data of certificate parameters paraCert_{j,i} required for an operation in the message authentication by a receiver, thereby constantly reducing the communication quantity and the operation quantity of the receiver. However, by the hash chain structure of the μTPCT-based μTESLA protocol, it is impossible to perform a message authentication any more when a communication interruption during two or more intervals has occurred.

In summary, the tree-based authentication structure increases the communication quantity and the operation quantity when the tree becomes high. The hash chain-based authentication structure has solved the problem of the tree-based authentication structure. However, by the hash chain-based authentication structure, the authentication is impossible after a communication interruption has occurred during a relatively long time.

### SUMMARY OF THE INVENTION

The prevent invention has been made in an effort to solve the above-described problems associated with the prior art, and the present invention provides a system and method for sensor network authentication based on an XOR chain, in which a receiving node can successfully perform an authentication any time if it receives a certificate parameter even after interruption of communication for long time.

Also, the present invention provides a system and method for sensor network authentication based on a tree using an XOR chain, which can authenticate a transmitting node (transmitter) and a message by only a small quantity of fixed operations regardless of the number of key chains, by using parameters of first and second key chain parameter sequences generated from a key chain including sequentially arranged keys in the authentication.

Further, the present invention provides a system and method for sensor network authentication based on an XOR chain, which can authenticate a transmitting node and a message by only a small quantity of fixed operations regardless of the number of transmitting nodes, by generating first and second certificates of each transmitting node by an XOR chain and XORing the certificates.

Moreover, the present invention provides a system and method for sensor network authentication based on an XOR chain, in which values of generated keys and certificates should be different according to the intervals and it is impossible to infer information on an unpublished key.

According to an aspect of the present invention for achieving the above object, there is provided a method for sensor network authentication based on an XOR chain, which authenticates a transmitting node and a message in a sensor network including a central server, a plurality of transmitting nodes, and a plurality of receiving nodes, the method including: (a) receiving an initial key from the central server, generating a key chain from the initial key, generating a first key chain parameter sequence from the key chain, generating authentication information by XORing all the first key chain parameter sequence, and generating a second key chain parameter sequence by XORing each parameter of the first key chain parameter sequence with the authentication information, by each of the transmitting nodes; (b) transmitting first and second parameters of the same position in the first and second key chain parameter sequences of the transmitting node together with a message by the transmitting node; and (c) XORing the first and second parameters and comparing a result of the XOR operation with the authentication information, thereby authenticating the message, by the receiving node.

Preferably, the method may further include: (a2) generating a first certificate of each transmitting node from authentication information of each transmitting node, generating a verification certificate by XORing all the first certificates of the transmitting nodes, and generating a second certificate of each transmitting node by XORing the first certificate of each transmitting node with the verification certificate, by the central server; (b2) transmitting first and second certificates of the transmitting node to the receiving node by the transmitting node; and (c2) XORing the first and second certificates and comparing a result of the XOR operation with the verification certificate, thereby authenticating the transmitting node, by the receiving node.

In step (a), a series of partial key chains are generated by repeatedly applying first and second hash functions with the initial key as a seed key, wherein a partial key chain is generated by repeatedly applying the first hash function to the seed key and a key obtained by hashing a second key of the partial key chain by the second hash function is determined as a seed key for a previous partial key chain, and initial keys of the series of partial key chains are arranged according to a sequence of the partial key chains, so as to generate a key chain of the transmitting node.

Also, in step (a), parameters of the first key chain parameter sequence are obtained by adding a time stamp to each key of the key chain.

In step (b), first and second parameters of the same position are sequentially selected and transmitted in the first and second key chain parameter sequences.

Also, in step (b), first and second parameters are sequentially selected and transmitted in a direction opposite to a direction, in which keys have been generated, in the first and second key chain parameter sequences.

It is preferred that the first parameter is hashed and a hashed value of the first parameter is applied to the XOR operation.

According to another aspect of the present invention for achieving the above object, there is provided a method for sensor network authentication based on an XOR chain, which authenticates a transmitting node and a message in a sensor network including a central server, a plurality of transmitting nodes, and a plurality of receiving nodes, the method including: (a) selecting an initial key for each transmitting node, generating a key chain from the initial key, generating a first key chain parameter sequence from the key chain of each transmitting node, generating authentication information by XORing all the first key chain parameter sequence, and generating a second key chain parameter sequence by XORing each parameter of the first key chain parameter sequence with the authentication information, by the central server; (b) transmitting first and second parameters of the same position in the first and second key chain parameter sequences of the transmitting node together with a message by the transmitting node; and (c) XORing the first and second parameters and comparing a result of the XOR operation with the authentication information, thereby authenticating the message, by the receiving node.

According to another aspect of the present invention, there is provided a computer-readable recording medium in which a program executing the method of claim 1 is recorded.

According to another aspect of the present invention, there is provided a system for sensor network authentication based on an XOR chain in a sensor network, the system including: a central server for generating and transmitting an initial key; a plurality of transmitting nodes, each of which receives the initial key from the central server, generates its own key chain from the initial key, generates a first key chain parameter sequence from its own key chain, generates authentication information by XORing all the first key chain parameter sequence, and generates a second key chain parameter sequence by XORing each parameter of the first key chain parameter sequence with the authentication information; and a receiving node for receiving first and second parameters of the same position in the first and second key chain parameter sequences together with a message from the transmitting node, and XORing the first and second parameters and comparing a result of the XOR operation with the authentication information, thereby authenticating the message.

It is preferred that the central server generates a first certificate of each transmitting node from authentication information of each transmitting node, generates a verification certificate by XORing all the first certificates of the transmitting nodes, and generates a second certificate of each transmitting node by XORing the first certificate of each transmitting node with the verification certificate; and the transmitting node transmits first and second certificates of the transmitting node to the receiving node, and XORs the first and second certificates and comparing a result of the XOR operation with the verification certificate, thereby authenticating the transmitting node.

According to another aspect of the present invention, there is provided a system for sensor network authentication based on an XOR chain in a sensor network, the system comprising: a plurality of transmitting nodes; a plurality of receiving nodes; and a central server for generating a key chain of each transmitting node, generating a first key chain parameter sequence from the key chain, generating authentication information of each transmitting node by XORing all the first key chain parameter sequence, and generating a second key chain parameter sequence by XORing each parameter of the first key chain parameter sequence with the authentication information, wherein the transmitting node transmits first and second parameters of the same position in the first and second key chain parameter sequences together with a message, and the receiving node XORs the first and second parameters and compares a result of the XOR operation with the authentication information, thereby authenticating the message.

As described above, in the system and method for sensor network authentication based on an XOR chain according to the present invention, a message authentication is performed by generating first and second key chain parameter sequences by an XOR chain and XORing parameters of the same position in the first and second key chain parameter sequences. Therefore, a receiving node can successfully perform an authentication any time if it receives a certificate parameter even after interruption of communication for long time.

Also, in the system and method for sensor network authentication based on an XOR chain according to the present invention, a transmitting node authentication is performed by generating first and second certificates of each transmitting node from an XOR chain and XORing the certificates. Therefore, it is possible to authenticate a transmitting node by only a small quantity of fixed operation regardless of the number of transmitting nodes.

Moreover, in the system and method for sensor network authentication based on an XOR chain according to the present invention, parameters are sequentially selected, hashed, and authenticated based on the hashed values pair by pair in each interval of the first and second parameter sequences. Therefore, the generated keys and values of the certificates are different according to the intervals and it is impossible to infer information on an unpublished key, which can enhance the security.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 illustrates an example of an entire sensor network construction for carrying out the present invention;

FIGS. 2a to 2c are flowcharts for describing a method for a sensor network authentication according to an embodiment of the present invention;

FIG. 3 illustrates a structure of a key chain according to an embodiment of the present invention;

FIG. 4 illustrates a structure of parameters based on an XOR chain according to an embodiment of the present invention;

FIG. 5 illustrates a structure of certificates based on an XOR chain according to an embodiment of the present invention;

FIGS. 6a to 6c are tables and a graph for comparison between the present invention and the prior art.

### DETAILED DESCRIPTION OF EXEMPLARY EMBODIMENTS

Hereinafter, exemplary embodiments of the present invention will be described below in detail with reference to the accompanying drawings such that those skilled in the art to which the present invention pertains can easily practice the present invention.

In the following description, the same elements will be designated by the same reference numerals and a repetitive description thereof will be omitted.

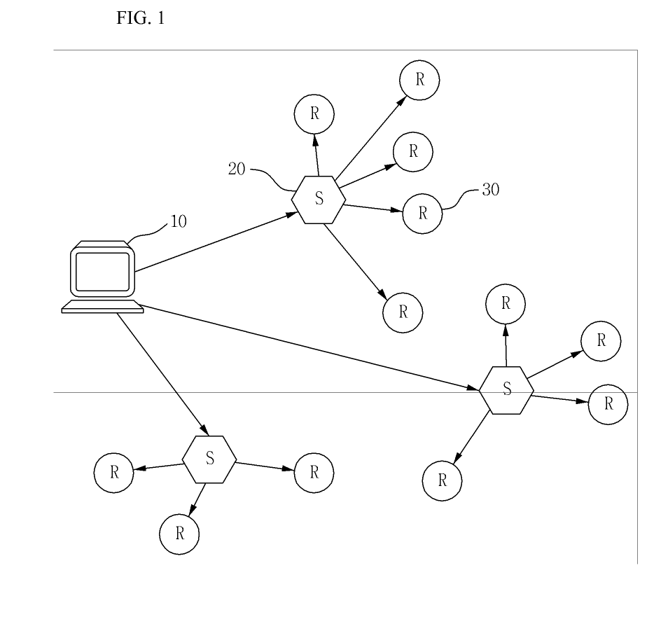

First, an example of an entire sensor network construction for carrying the present invention will be described with reference to FIG. 1.

Referring to FIG. 1, a sensor network according to an embodiment of the present invention includes a central server 10, transmitting nodes 20, and a receiving node 30.

The receiving node 30 is a sensor device collecting surrounding environmental information, and has a sensor proper for information to be collected. The receiving node 30 transmits the collected information to the transmitting node 20 to which the receiving node 30 belongs.

The transmitting node 20 is a computing device for accumulating the information collected by the receiving node 30. The sensor network includes two or more transmitting nodes 20. Each transmitting node 20 accumulates data from the receiving node 30 belonging to the transmitting node 20 and transmits the accumulated information to the central server 10.

The central server 10 is a computing device for collecting all the data collected or accumulated in the sensor network. That is, all the information collected by the receiving node 30 is collected in the central server 10 through the transmitting node 20.

In the meantime, the transmitting node 20 may transmit data to the receiving node 30, in order to update software or request a query for accumulating the collected information. Since the transmitting node 20 usually broadcasts data in order to transmit the data, an attacker may maliciously intercept the data or distort the transmitted query or data.

In order to prevent occurrence of such a trouble, the transmitting node 20 transmits a certificate or parameter together with the broadcasted data or message. By receiving and authenticating the certificate or parameter from the transmitting node 20, the receiving node 30 can receive only a genuine message from a genuine transmitting node.

At this time, the authentication is performed in two ways. One way corresponds to a message authentication by a parameter of a transmitting node, and the other way corresponds to an authentication of the transmitting node by a certificate of the transmitting node. That is, the message authentication refers to a verification in which the receiving node 30 determines if a received message (or data) is a message from a genuine transmitting node 20. Further, the authentication of the transmitting node refers to a verification of if the transmitting node 20 having transmitted a message genuinely belongs to the central server 10.

For example, when the receiving node 30 initially operates or re-operates, the receiving node 30 selects one of surrounding transmitting nodes as the transmitting node to which the receiving node 30 belongs. At this time, the selected transmitting node may be a malicious node pretending to be the transmitting node. Then, the receiving node 30 receives a message from the malicious node, so that the genuineness of the message is approved but the genuineness of the transmitting node is not approved.

In order to prevent such an erroneous selection, the transmitting node 20 transmits first and second parameters for message authentication and transmits first and second certificates for authentication of the transmitting node. Then, the receiving node 30 may simultaneously receive and authenticate the first and second parameters and the first and second certificates or individually receive and authenticate the first and second parameters and the first and second certificates.

Meanwhile, all of the first and second parameters and the first and second certificates are generated by an XOR chain, and the authentication is performed by using a resultant obtained by XORing the first element and the second element.

The first and second parameters are separately generated for each transmitting node. A key chain is generated from an initial key for each transmitting node, and a series of first parameters (or a first key chain parameter sequence) are then generated from the generated key chain. Through an XOR chain, a series of second parameters (or a second key chain parameter sequence) are generated from the series of first parameters. As described above, the first and second parameters are generated by the XOR chain, which implies that a resultant value of an XOR operation of a pair of the first and second parameters are all the same. Therefore, the authentication is performed by determining if resultant values of XOR operations of pairs of the first and second parameters are identical to each other.

Further, the first and second certificates are generated from certificates of all transmitting nodes. That is, a series of first certificates include certificates of transmitting nodes arranged in series. Through an XOR chain, a series of second certificates are generated from the series of first certificates. Therefore, since first and second certificates are generated by the XOR chain also, the authentication is performed based on a resultant value of an XOR operation of a pair of the first and second certificates.

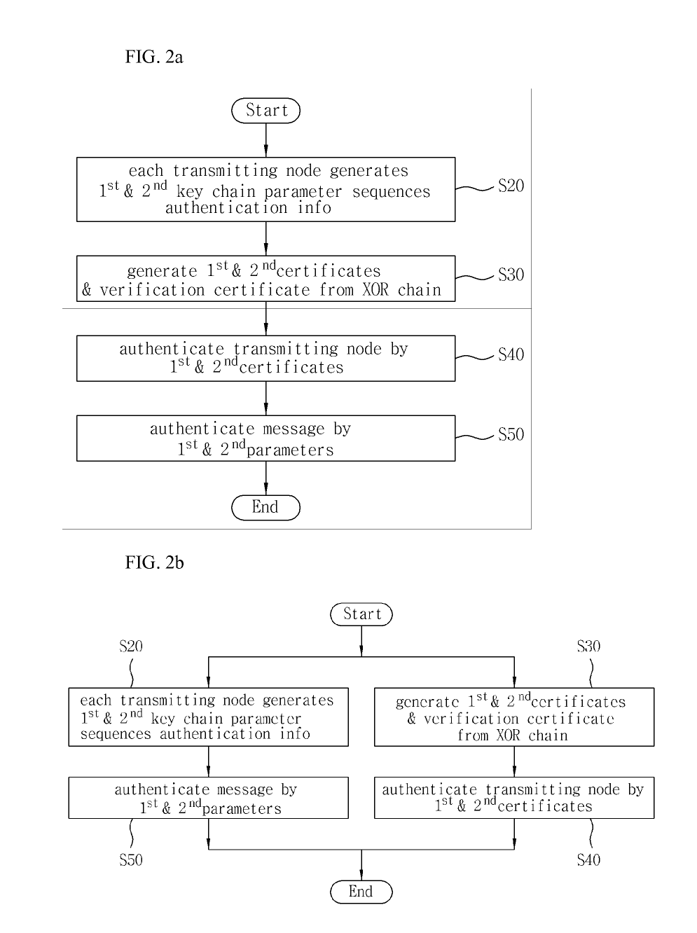

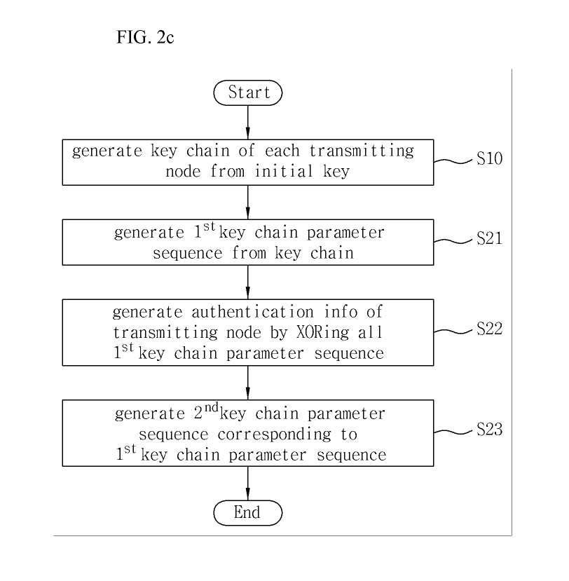

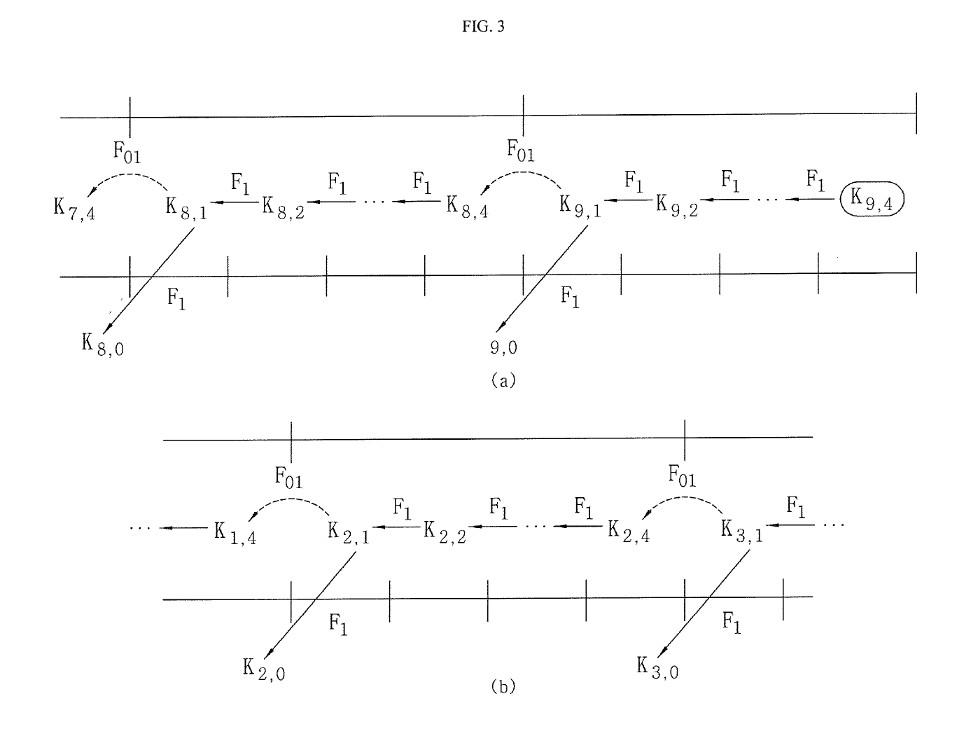

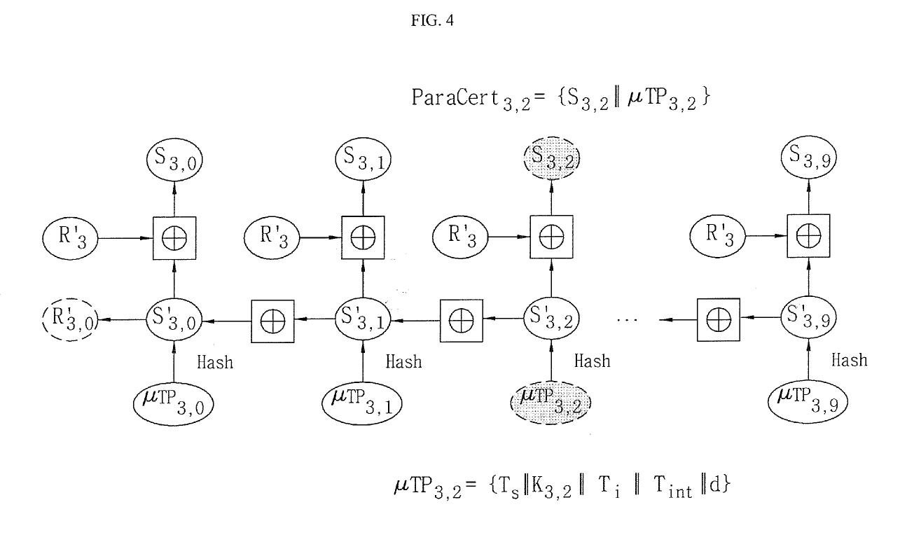

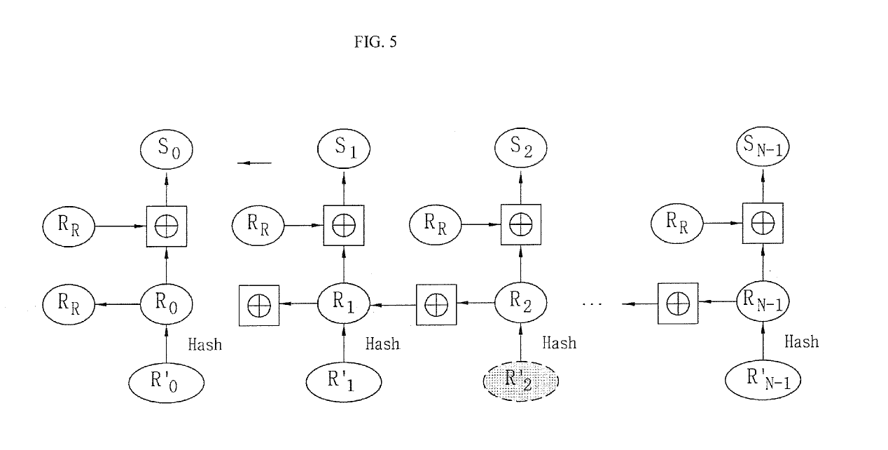

Next, a method for a sensor network authentication based on an XOR chain according to an embodiment of the present invention will be described with reference to FIGS. 2a to 5. FIGS. 2a to 2c are flowcharts for describing a method for a sensor network authentication according to an embodiment of the present invention, FIG. 3 illustrates a structure of a key chain according to an embodiment of the present invention, FIG. 4 illustrates a structure of parameters based on an XOR chain according to an embodiment of the present invention, and FIG. 5 illustrates a structure of certificates based on an XOR chain according to an embodiment of the present invention.

As shown in FIG. 2a, a method for a sensor network authentication according to an embodiment of the present invention includes: generating first and second key chain parameter sequences and authentication information of each transmitting node by an XOR chain (step S20); generating first and second certificates and a verification certificate of a transmitting node by an XOR chain (step S30); authenticating the transmitting node by the first and second certificates of the transmitting node (step S40); and authenticating a message by the first and second parameters (step S50).

As shown in FIG. 2b, instead of the sequence in FIG. 2a, a sequence of the step (S20) of generating parameter sequences and authentication information and the step (S50) of authenticating a message and a sequence of the step (S30) of generating certificates and the step (S40) of authenticating the transmitting node may be performed in parallel.

Now, each step will be described in more detail.

First, key chain parameter sequences and authentication information are generated (step S20).

As shown in FIG. 2c, step S20 includes steps of: generating a key chain (S10); generating a first key chain parameter sequence (S21); generating authentication information of a transmitting node (S22); and generating a second key chain parameter sequence (S23).

That is, the transmitting node 20 receives an initial key from the central server 10, and generates a key chain of the transmitting node by repeatedly applying a hash function to a seed key, which is the initial key (step S10).

For example, as shown in FIG. 3a, if the initial key is K_{9,4}, the transmitting node 20 receives the initial key K_{9,4} and generates a final partial key chain by repeatedly applying a first hash function F₁( ) by using the initial key as a seed key. Herein, the generation of a partial key chain by repeatedly applying a first hash function F₁( ) can be defined by equation (1) below.

K_{i,t-1}=F₁(K_{i,t}),(1≦t≦m−1) (1)

In equation (1), F₁( ) refers to a first hash function and m indicates the number of partial key chains).

As used herein, the number of partial key chains (small key chains) is also indicated by interval₀ or Δ₀.

In FIG. 3a, with a seed key K_{9,4} as an input value, the first hash function F₁( ) is repeatedly operated four (m−1) times, to generate one partial key chain (short key chain) {K_{9,0}, K_{9,1}, K_{9,2}, K_{9,3}, K_{9,4}}.

At this time, K_{9,0} is selected as an initial key of the final partial key chain.

Next, by using equation (2) below, a next key (or the second key) of the initial key of the final partial key chain is hashed by a second hash function. Then, a key obtained through the hashing is determined as a seed key of the next partial key chain.

K_{t-1,m-1}=F₀₁(K_{t,1}),(0≦t≦n) (2)

That is, in FIG. 3a, F₀₁(K_{9,1}), which is obtained by hashing K_{9,1}, which is the second key of the final partial key chain, by the second hash function F₀₁( ), is determined as a seed key K_{8,4} of the partial key chain just prior to the final partial key chain.

As in the generation of the final partial key chain as described above, the previous (or the 8^{th}) partial key chain {K_{8,0}, K_{8,1}, K_{8,2}, K_{8,3}, K_{8,4}} is generated by using equation (1). Further, K_{8,0} is selected as an initial value of the 8^{th} partial key chain.

By repeatedly applying equations (1) and (2), a series of partial key chains are generated. Then, a key chain for a transmitting node is generated by arranging initial keys of the series of partial key chains according to the sequence of the partial key chains.

By repeating the process described above, it is possible to generate a total of central server 10 partial key chains. The first key chain finally generated is {K_{0,0}, K_{0,1}, K_{0,2}, K_{0,3}, K_{0,4}}. Therefore, initial keys of the series of partial key chains are K_{0,0}, K_{1,0}, K_{2,0}, . . . , K_{8,0}, K_{9,0}.

By arranging the initial keys according to the sequence of the partial key chains, a key chain of a transmitting node is generated. That is, in the example described above, the generated key chain of the transmitting node 20 is {K_{0,0}, K_{1,0}, K_{2,0}, . . . , K_{8,0}, K_{9,0}}.

Next, a first key chain parameter sequence is generated from the key chain of the transmitting node (step S21). Especially, parameters of the first key chain parameter sequence are obtained by using the key chain of the transmitting node, each key of which includes a time stamp.

That is, the first key chain parameter sequence {μTP_{j,i}}ᵢ of the transmitting node j is obtained by equation (3) below.

μTP_{j,i}={Tₛ∥K_{i,0}∥Tᵢ∥Tᵢₙₜ∥d} (3)

In equation (3), Tₛ, Tᵢ, and Tᵢₙₜ indicate a current time, a start time, and a size of a synchronization interval, respectively, and d indicates a delay time. That is, Tₛ refers to a current time for time synchronization between a transmitting node and a receiving node of the sensor network, Tᵢ refers to a start time at which the transferred initial key value is used, Tᵢₙₜ refers to a size of a synchronization interval of a key chain, d refers to a message key exposure delay time, and the distributed K_{j,i} is used after a time delay corresponding to d.

At this time, each parameter is called a μTESLA parameter.

In the above example, the key chain of the transmitting node j is {K_{0,0}, K_{1,0}, K_{2,0}, . . . , K_{8,0}, K_{9,0}}, and parameter μTP_{j,i} is generated from each key by applying equation (3). That is, a parameter sequence {μTP_{j,0}, μTP_{j,1}, μTP_{j,2}, . . . , μTP_{j,8}, μTP_{j,9}} is generated. This parameter sequence is called a first key chain parameter sequence, and each parameter of the parameter sequence is called a first parameter.

In the meantime, the keys are published in a direction opposite to the direction in which the key chain has been generated. That is, the keys or parameters of the first key chain parameter sequence or the key chain of the transmitting node are published in the order of the sequence. For example, the keys of the key chain of the transmitting node are generated in a sequence of K_{9,0}, K_{8,0}, K_{7,0}, . . . , K_{1,0}, K_{0,0} and are published in a sequence of K_{0,0}, K_{1,0}, K_{2,0}, K_{8,0}, K_{9,0}.

Then, as shown in FIG. 4, authentication information of the transmitting node is generated by XORing all the first key chain parameter sequences (step S22). Especially, the first parameter is hashed so that a hashed value is applied to the XOR operation.

That is, authentication information R′ⱼ of the transmitting node j is obtained by equation (4) below.

R′ⱼ={H(μTP_{j,0})⊕H(μTP_{j,1})⊕ . . . ⊕H(μTP_{j,n-2})⊕H(μTP_{j,n-1})} (4)

In equation (4), H indicates a third hash function.

Next, XORC (XOR Chain)-based second parameters are generated (step S23).

Further, as shown in FIG. 4, the second key chain parameter sequence is generated to include parameters (second parameters) corresponding to the same position of the parameters (first parameters) of the first key chain parameter sequence, and the second parameters are generated by XORing the first parameters with the authentication of the transmitting node. Especially, it is preferred that the first parameter is hashed for the XOR operation and a hashed value of the first parameter is applied to the XOR operation.

That is, according to equation (5) below, by using the authentication information R′ⱼ of the transmitting node j, the second parameter S_{j,i} for the μTESLA parameter value of the i^{th} partial key chain (or short chain) of the transmitting node j is generated.

S_{j,i}={R′ⱼ⊕H(μTP_{j,i})} (5)

In equation (5), H indicates a hash function.

FIG. 4 illustrates a construction of a circuit for obtaining the second key chain parameter sequence and the authentication of the transmitting node as described above.

In the embodiment described above, the transmitting node 20 receives an initial key from the central server 10 and generates its own first and second parameter sequences and authentication information. However, according to another embodiment, the central server 10 generates first and second key chain parameter sequences and authentication information of each transmitting node by using an initial key and then transmits the generated information to each transmitting node. The former embodiment is problematic in that the quantity of computation by the transmitting node 20 is too much although the quantity of data transmitted from the central server 10 to the transmitting node 20 is small, and the latter embodiment is problematic in that the quantity of data transmitted from the central server 10 to the transmitting node 20 is too much although the quantity of computations by the transmitting node 20 is small.

Next, the step (S30) of generating a verification certificate and first and second certificates of the transmitting node by using an XOR chain is described in detail.

First, by hashing the authentication information of each transmitting node, a first certificate of each transmitting node is obtained. That is, by using equation (6), the authentication information R′ⱼ of the transmitting node j is hashed by a hash function H, so as to generate a first certificate Rⱼ.

Rⱼ=H(R′ⱼ) (6)

Further, as shown in FIG. 5, a verification certificate is generated by XORing all the first certificates of the transmitting nodes. That is, the verification certificate R_{R} is obtained by equation (7) below.

R_{R}={R₀⊕R₁⊕ . . . ⊕R_{N-1}} (7)

In equation (7), Rⱼ indicates the first certificate of the transmitting node j and N indicates the number of transmitting nodes.

Next, by XORing the first certificate of each transmitting node with the verification certificate, the second certificate of each transmitting node is generated.

That is, as noted from equation (8) below, the second certificate S₁ for the first certificate of the transmitting node j is generated by using the verification certificate R_{R}.

sⱼ={R_{R}⊕Rⱼ} (8)

In equation (8), Rⱼ indicates the first certificate of the transmitting node j.

Next, the step (S50) of authenticating a message through the first and second parameters will be described.

The receiving node 30 receives authentication information of the transmitting node 20 in advance (step S51). That is, the receiving node 30 receives and stores the authentication information R′ⱼ (or the second certificate Sⱼ) of the transmitting node j, to which the receiving node 30 belongs.

Preferably, the receiving node 30 receives a certificate, which is configured by concatenating the Identifier (ID) and the authentication information of the transmitting node 20. The certificate of the transmitting node j is configured by concatenating the identifier IDⱼ of the transmitting node j and the authentication information R′ⱼ of the transmitting node j. That is, the certificate Sⱼ of the transmitting node j can be defined by {R′ⱼ∥IDⱼ} as shown in equation (9) below.

Sⱼ={R′ⱼ∥IDⱼ} (9)

Further, the transmitting node 20 sequentially transmits, together with the message, first and second parameters of the same position in the first and second key chain parameter sequences (step S52).

That is, in order to notify the receiving node 30 of the key K_{i,0} possessed by the transmitting node j, the transmitting node j periodically broadcasts first certificate parameters ParaCert_{j,i} including the first parameter (μTESLA parameter) and the second parameter, as defined by equation (10) below.

ParaCert_{j,i}={S_{j,i}∥μTP_{j,i}} (10)

At this time, in broadcasting the first certificate parameters ParaCert_{j,i} parameters of the first and second parameter sequences are concatenated one pair by one pair and transmitted in sequence. For example, in the example shown in FIG. 4, the parameters are transmitted in the sequence of {S_{j,0}∥μTP_{j,0}}, {S_{j,1}∥μTP_{j,1}}, {S_{j,2}∥μTP_{j,2}}, . . . , {S_{i,9}∥μTP_{j,9}}.

Further, the receiving node 30 XORs the first and second parameters and authenticates the message through comparison between a result of the XOR operation and the authentication information (step S53).

That is, the receiving node 30 receives the first and second parameters {S_{j,i}∥μTP_{j,i}} of the transmitting node j and XORs them. At this time, the first parameter is hashed and the hashed value is subjected to the XOR operation. Then, through comparison as shown in equation (11) below, the message authentication is performed based on if a result of the XOR operation is identical to the authentication information.

$${R}_{j}^{′} = H ( μ {TP}_{j , i} ) ⊕ {S}_{j , i} \\ {S}_{j} {=}^{?} {R}_{j}^{′} \vert \vert {ID}_{j} \qquad ( 11 )$$

In the example shown in FIG. 4, when transmitting node #3 transmits a message, the receiving node 30 receives a first certificate parameter ParaCert_{3,2}, concatenates R′₃ calculated by equation (11) with ID₃ of transmitting node #3, and checks if the concatenated value is identical to the certificate value S₃ of transmitting node #3. When they are identical, the receiving node 30 stores the received data.

Next, the step (S40) of authenticating a transmitting node through the first and second certificates will be described.

The receiving node 30 receives a verification certificate in advance (step S41).

Then, the transmitting node 20 transmits the first and second certificates to the receiving node 30 (step S42). That is, the transmitting node j periodically broadcasts the second certificate parameter ParaCertⱼ, which includes the first certificate and the second certificate as defined by equation (12) below.

ParaCertⱼ={Rⱼ∥sᵢ} (12)

In broadcasting the second certificate parameter ParaCertⱼ, the first certificate and the second certificate are concatenated and transmitted in pairs. For example, for transmitting nodes #0, #1, . . . , #(N−1), {S₀∥R₀}, {S₁∥R₁}, {S₂∥R₂}, {S₉∥R₉} are transmitted pair by pair.

Further, the receiving node 30 XORs the first and second certificates and authenticates the transmitting node j through comparison between a result of the XOR operation and the verification certificate (step S43).

That is, through comparison as shown in equation (13) below, the receiving node 30 authenticates the transmitting node j based on if a result of the XOR operation is identical to the verification certificate.

$${R}_{R} {=}^{?} \{ {s}_{j} ⊕ {R}_{j} \} \qquad ( 13 )$$

In equation (13), Rⱼ indicates the first certificate of the transmitting node j.

In the example shown in FIG. 5, when transmitting node #2 sends a message, the receiving node 30 receives a second certificate parameter ParaCert₃.

Although the step (S50) of authenticating a message through the first and second parameters and the step (S40) of authenticating a transmitting node through the first and second certificates are separately performed in the above description, the two steps may be simultaneously performed by the receiving node 30 according to another embodiment of the present invention.

For example, the receiving node 30 receives and stores the verification certificate and the authentication information of the transmitting node j in advance. Then, the receiving node 30 receives all of the first and second certificates and the first and second parameters. Then, the receiving node 30 performs the message authentication by XORing the first and second parameters and comparing a result of the XOR operation with the authentication information and simultaneously authenticates the transmitting node j by XORing the first and second certificates and comparing a result of the XOR operation with the verification certificate.

Further, the transmitting node 20 may apply the authentication method of the transmitting node in order to authenticate the central server 10. That is, the transmitting node 20 receives and stores a verification certificate in advance. When the transmitting node 20 receives a message (or data) from the central server 10, the transmitting node 20 simultaneously receives a second certificate parameter ParaCertⱼ. Then, the transmitting node 20 authenticates the central server 10 by XORing the first and second certificates included in the second certificate parameter and comparing a result of the XOR operation with the verification certificate.

It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block or blocks.

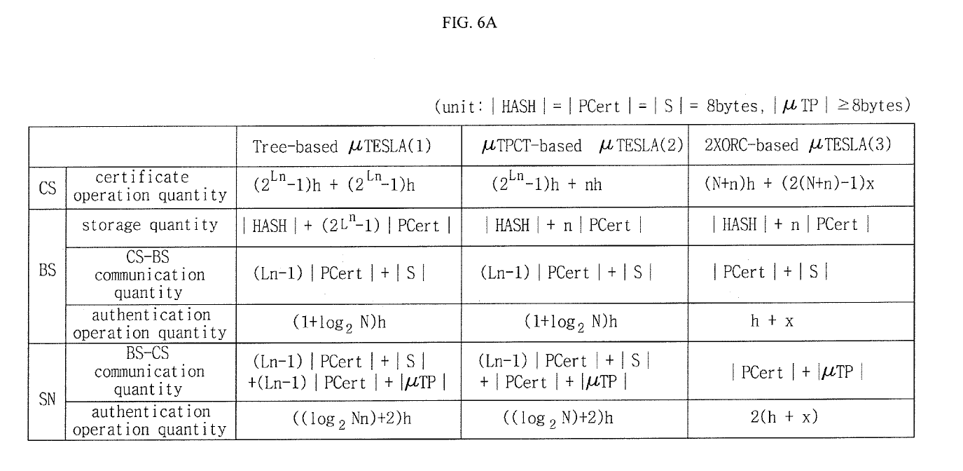

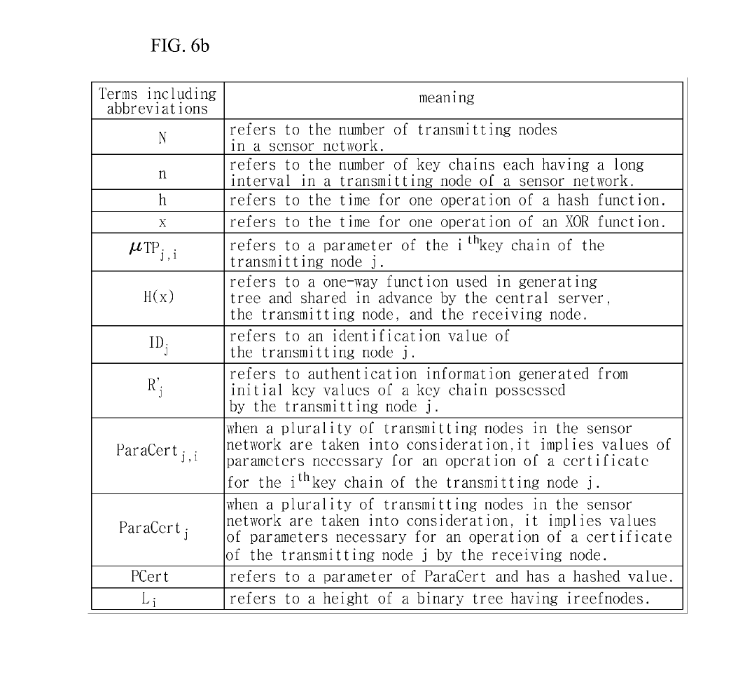

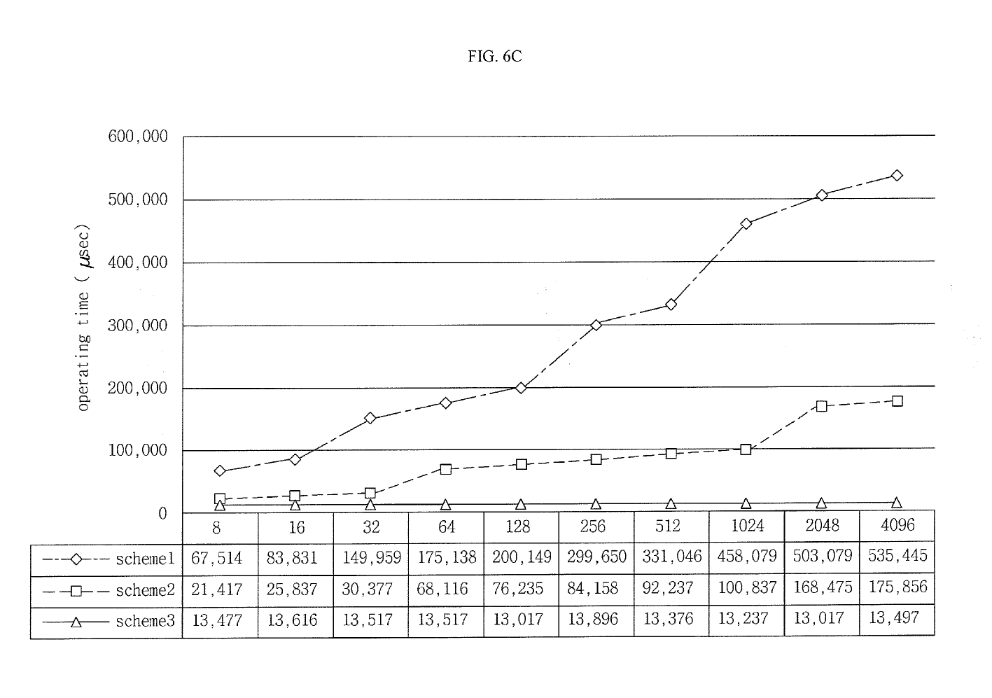

Next, effects of the present invention will be described in more detail with reference to FIGS. 6a to 6c.

In order to identify the efficiency of the present invention, several schemes including the inventive scheme have been analyzed in view of the storage, communication, and operation overhead, the message restoration, and the stability of the proposed certificate structure. In the analysis, the present invention (2XORC-based μTESLA) has been compared with the tree-based μTESLA and μTPCT-based μTESLA. It is assumed that each of N transmitting nodes in the sensor network includes n long key chains.

Results of the efficiency analysis are as shown in FIG. 6a. Terms used in FIG. 6a are defined in FIG. 6b. Especially, |Hash|, |Pcert|, and |S| indicate lengths (bytes) of the elements.

As shown in FIG. 6a, in the efficiency comparison in view of the operation quantity of the central server, the present invention (2XORC-based μTESLA)>the μTPCT-based μTESLA>the tree-based μTESLA.

In the efficiency comparison in view of the storage overhead of the transmitting node, the μTPCT-based μTESLA=the present invention (2XORC-based μTESLA)>the tree-based μTESLA.

In the efficiency comparison in view of the communication quantity between the central server and the transmitting node, the operation quantity of the transmitter, and the storage quantity of the receiver, the present invention (2XORC-based μTESLA)>the μTPCT-based μTESLA=the tree-based μTESLA.

In the efficiency comparison in view of the communication quantity between the transmitting node and the receiving node, the present invention (2XORC-based μTESLA)>the μTPCT-based μTESLA>the tree-based μTESLA.

In the efficiency comparison in view of the operation quantity of the receiving node, the present invention (2XORC-based μTESLA)>the μTPCT-based μTESLA>the tree-based μTESLA.

According to the present invention, it is possible to perform both the transmitter (transmitting node) authentication and the message authentication by efficient operations including only two times of XOR operations and two times of hash operations.

In the present invention and the μTESLA scheme, a previous distribution technique has been used in order to transfer a certificate of a route trusted by all transmitting and receiving nodes. Therefore, even when a network is interrupted for long time, it is possible to authenticate a message any time by receiving only the first and second certificate parameters.

FIG. 6c is a graph illustrating an analysis of the operation quantity for transmitting node and message authentication in a sensor node based on an assumption that the number of transmitters and the number of long chains are in proportion to powers of 2. The curves in the graph prove that the present invention can support a fixed authentication operation quantity that is not in proportion to the number of transmitters and the number of long chains.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

The present invention can be applied to development of an XOR chain-based sensor network authentication system, which generates first and second key chain parameter sequences by an XOR chain and then authenticates a message through an XOR operation of the parameter sequences, and generates first and second certificates by an XOR chain and then authenticates a transmitting node through an XOR operation of the certificates in a sensor network including a central server, a transmitting node, and a receiving node.

What is claimed is:

1. A method for sensor network authentication based on an XOR chain, which authenticates a transmitting node and a message in a sensor network including a central server, a plurality of transmitting nodes, and a plurality of receiving nodes, the method comprising the steps of:
(a) receiving an initial key from the central server, generating a key chain from the initial key, generating a first key chain parameter sequence from the key chain, generating authentication information by XORing all the first key chain parameter sequence, and generating a second key chain parameter sequence by XORing each parameter of the first key chain parameter sequence with the authentication information, by each of the transmitting nodes;
(b) transmitting first and second parameters of the same position in the first and second key chain parameter sequences of the transmitting node together with a message by the transmitting node; and
(c) XORing the first and second parameters and comparing a result of the XOR operation with the authentication information, thereby authenticating the message, by the receiving node.

2. The method of claim 1, further comprising the steps of:
(a2) generating a first certificate of each transmitting node from authentication information of each transmitting node, generating a verification certificate by XORing all the first certificates of the transmitting nodes, and generating a second certificate of each transmitting node by XORing the first certificate of each transmitting node with the verification certificate, by the central server;
(b2) transmitting first and second certificates of the transmitting node to the receiving node by the transmitting node; and
(c2) XORing the first and second certificates and comparing a result of the XOR operation with the verification certificate, thereby authenticating the transmitting node, by the receiving node.

3. The method of claim 1, wherein, in step (a),
a series of partial key chains are generated by repeatedly applying first and second hash functions with the initial key as a seed key, wherein a partial key chain is generated by repeatedly applying the first hash function to the seed key and a key obtained by hashing a second key of the partial key chain by the second hash function is determined as a seed key for a previous partial key chain, and
initial keys of the series of partial key chains are arranged according to a sequence of the partial key chains, so as to generate a key chain of the transmitting node.

4. The method of claim 3, wherein, in step (a), parameters of the first key chain parameter sequence are obtained by adding a time stamp to each key of the key chain.

5. The method of claim 1, wherein, in step (b), first and second parameters of the same position are sequentially selected and transmitted in the first and second key chain parameter sequences.

6. The method of claim 5, wherein, in step (b), first and second parameters are sequentially selected and transmitted in a direction opposite to the direction in which keys have been generated, in the first and second key chain parameter sequences.

7. The method of claim 1, wherein the first parameter is hashed and a hashed value of the first parameter is applied to the XOR operation.

8. A method for sensor network authentication based on an XOR chain, which authenticates a transmitting node and a message in a sensor network including a central server, a plurality of transmitting nodes, and a plurality of receiving nodes, the method comprising the steps of:
(a) selecting an initial key for each transmitting node, generating a key chain from the initial key, generating a first key chain parameter sequence from the key chain of each transmitting node, generating authentication information by XORing all the first key chain parameter sequence, and generating a second key chain parameter sequence by XORing each parameter of the first key chain parameter sequence with the authentication information, by the central server;
(b) transmitting first and second parameters of the same position in the first and second key chain parameter sequences of the transmitting node together with a message by the transmitting node; and
(c) XORing the first and second parameters and comparing a result of the XOR operation with the authentication information, thereby authenticating the message, by the receiving node.

9. A computer-readable recording medium in which a program executing the method of claim 1 is recorded.

10. A system for sensor network authentication based on an XOR chain in a sensor network, the system comprising:
a central server for generating and transmitting an initial key;
a plurality of transmitting nodes, each of which receives the initial key from the central server, generates its own key chain from the initial key, generates a first key chain parameter sequence from its own key chain, generates authentication information by XORing all the first key chain parameter sequence, and generates a second key chain parameter sequence by XORing each parameter of the first key chain parameter sequence with the authentication information; and
a receiving node for receiving first and second parameters of the same position in the first and second key chain parameter sequences together with a message from the transmitting node, and XORing the first and second parameters and comparing a result of the XOR operation with the authentication information, thereby authenticating the message.

11. The system of claim 10, wherein the central server generates a first certificate of each transmitting node from authentication information of each transmitting node, generates a verification certificate by XORing all the first certificates of the transmitting nodes, and generates a second certificate of each transmitting node by XORing the first certificate of each transmitting node with the verification certificate; and
the transmitting node transmits first and second certificates of the transmitting node to the receiving node, and XORs the first and second certificates and comparing a result of the XOR operation with the verification certificate, thereby authenticating the transmitting node.

12. A system for sensor network authentication based on an XOR chain in a sensor network, the system comprising:
a plurality of transmitting nodes;
a plurality of receiving nodes; and
a central server for generating a key chain of each transmitting node, generating a first key chain parameter sequence from the key chain, generating authentication information of each transmitting node by XORing all the first key chain parameter sequence, and generating a second key chain parameter sequence by XORing each parameter of the first key chain parameter sequence with the authentication information,
wherein the transmitting node transmits first and second parameters of the same position in the first and second key chain parameter sequences together with a message, and
the receiving node XORs the first and second parameters and compares a result of the XOR operation with the authentication information, thereby authenticating the message.
